(19) United States
(12) Patent Application Publication
(10) Pub. No.: US 2005/0221191 A1
(43) Pub. Date: Oct. 6, 2005

(54) Lead alloy and lead storage battery using it

(76) Inventors: Yasuo Kondo, Hitachinaka (JP); Kyoko Honbo, Hitachinaka (JP); Masanori Sakai, Hitachiota (JP); Yasuhisa Aono, Hitachi (JP); Tokiyoshi Hirasawa, Ogawa (JP); Masayuki Terada, Ide (JP); Yoshifumi Yamada, Okabe (JP); Takayuki Kimura, Nabari (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/053,937

(22) Filed: Feb. 10, 2005

(30) Foreign Application Priority Data
Mar. 31, 2004 (JP) 2004-103679

(51) Int. Cl. H01M 4/68; C22C 11/06

(52) U.S. Cl. 429/245; 420/565

(57) ABSTRACT

An object of the present invention is to inhibit intergranular corrosion of a lead alloy by grain refining, and to prolong the life and improve the reliability of a lead battery using the alloy for a positive current collector in the battery. The intergranular corrosion of the lead alloy is inhibited by adding Sr to a Pb—Sn alloy to refine a cast structure and the recrystallized structure of a rolled material, and the hardness is improved by further adding Ca, Ba and Te. In addition, the rolled sheet of the lead alloy is used in the positive current collector of the lead storage battery.

### BACKGROUND OF THE INVENTION

1. Field of the Invention

The present invention relates to a highly corrosion resistant lead alloy and a lead storage battery using it for a current collector, particularly relates to the extension of the life and the improvement of the reliability of a lead storage battery, by using the rolled sheet of the highly corrosion resistant lead alloy with retarded intergranular corrosion, for the current collector.

2. Background Art

A lead storage battery has features of a low cost and high reliability, and therefore it is widely used as an uninterruptible power supply in an automobile, a computer backup unit or the like. For the electrode, a current collector made of a lead alloy coated with an active material is used. In these applications, the lead storage battery normally stands by in a charged state by trickle charge, and discharges electricity when power has failed. One of important technical subjects in these applications is to retard the deterioration of a positive current collector (the increase of resistance due to oxidation or a deformation due to a cubical dilatation) due to overcharge.

On the other hand, recently, there has been a need for increasing power and utilization factor, and accordingly in order to increase a contacting area with an active material, a current collector tends to be a thinner flat shape or have holes. Accordingly, a current collector is exposed to an increasingly severe corrosive environment, and an improvement in the corrosion resistance of a lead alloy used for it is a great development challenge.

For a lead alloy in a current collector, conventionally, a Pb—Sn—Sb or Pb—Sn—Ca lead alloy has been used. Particularly, the Pb—Sn—Ca lead alloy has high strength and causes little self-discharge, so that it is frequently used as the grid current collector of an enclosed lead storage battery. In addition, in order to improve the corrosion resistance of the current collector, lead alloys with various compositions have been proposed until now. For instance, JP Patent Publication (Kokai) No. 2000-77076 discloses a lead-base alloy used in a positive grid plate made of a Pb—Ca—Sn—X alloy, where an X element is at least one or more additives selected from the group consisting of Li, Sr and Ba. Specifically, the proposed lead alloy is a Pb-0.05 to 0.20 wt. % Ca-0.50 to 2.0 wt. % Sn alloy containing at least one or more elements among 0.01 to 0.3 wt. % Li, 0.01 to 3 wt. % Sr and 0.01 to 0.3 wt. % Ba However, a Pb—Ca—Sn alloy essentially has coarse crystal grains, so that it easily causes intergranular corrosion when used in a positive current collector, and anodically oxidized in a high-temperature environment, both of which cause the problems of the elongation of a plate, the deformation of a grid, consequent poor contact between a grid and an active material, and lead to the degradation of cell characteristics.

Subjects in the present invention are to solve the problem of intergranular corrosion in a conventional lead alloy, by controlling a structure, specifically, by refining crystal grains, and to provide a positive current collector superior in corrosion resistance; and objects of the present invention are thereby to inhibit the deterioration of a positive current collector due to overcharge and to provide a long-life lead storage battery superior in cycle characteristics.

### SUMMARY OF THE INVENTION

The present inventors have thought that in order to enhance corrosion resistance and prolong the life of a lead alloy by inhibiting intergranular corrosion, crystal grains should be refined by the control of a structure (the crystal grains). Specifically, in a constant-potential battery environment, so long as grain refining does not give a basic adverse effect on a corrosion reaction mechanism and a corrosion rate, a controlled small grain size extends the total length of crystal grain boundaries per unit weight and unit area, prolongs the rupture life by increasing corrosion length, and consequently increases the corrosion resistance. In the constant-current battery environment as well, so long as the grain refining does not give the basic adverse effect on a corrosion reaction mechanism and a corrosion rate, it should extend the total length of the crystal grain boundaries, reduce a corrosion current per unit length in the grain boundaries, and consequently increase the corrosion resistance.

However, even if the crystal grains of a Pb—Sn alloy and a Pb—Ca—Sn lead alloy are refined by such plastic working as rolling, the alloys have a recrystallization temperature in about room temperature as is conventionally known, so that recrystallization proceeds to coarsen the grains, which means that grain refining is nearly impossible.

For this reason, it is necessary for refinement of crystal grains to increase recrystallization temperature. The present inventors found that the addition of Sr inhibits crystal growth, that is, gives a pinning effect, and added Sr to a Pb—Sn alloy. Here, the amount of Sr to be added is necessary to balance with the amount of Sn. When a molten alloy solidifies, Sr not only refines a solidification structure through forming a Pb compound (a crystal nucleus) and a Sn compound (an eutectoid), but is also dispersed in the form of fine precipitates in a matrix after plastic-working such as rolling, thereby inhibits the crystal growth and increases recrystallization temperature. In the present invention, for the purpose of securing the hardness, or equivalently, the strength of the above described Pb—Sn—Sr alloy, a trace amount of either of Ba and Te, or Ca is also added. The lead alloy having the crystals thus controlled and the hardness thus adjusted is cold-rolled into a sheet of which at least one part has a recrystallized structure, and the sheet is used for the current collector of a lead battery.

In a lead alloy according to the present invention, Sr added in a Pb—Sn alloy refines a cast structure and the recrystallized structure of a rolled material to inhibit intergranular corrosion, and further added Ca, Ba and Te enable the extensive adjustment of hardness. In addition, the application of the rolled sheet of the lead alloy to the positive current collector of a lead storage battery improves corrosion resistance greatly, and can prolong the life and improve the reliability of the lead battery in the wide range of use.

### BRIEF DESCRIPTION OF THE DRAWINGS

FIG. 1 shows a structure observed with an optical microscope of a Pb-2.1 wt. % Sn-0.14 wt. % Sr alloy according to the present invention;

FIG. 2 shows a relation between a heat treatment temperature and a recrystallized grain size;

FIG. 3 shows a characteristic view showing a relation between an amount of Sr, Ba, Te and Ca added to a Pb-2 wt. % Sn alloy and micro-Vickers hardness;

FIG. 4 shows a characteristic view showing a relation between the ratio of Sn-added amount/Sr-added amount and intergranular-corroded depths in various alloys;

FIG. 5(A) and FIG. 5(B) are optical microphotographs for the cross sections of the corroded layer respectively in a Pb-2.1 wt. % Sn-0.14 wt. % Sr alloy and a Pb-1.5 wt. % Sn alloy;

FIG. 6 is a schematic view of a lead storage battery of one embodiment according to the present invention;

FIG. 7 is a schematic view of a lead storage battery of one embodiment according to the present invention;

FIG. 8 is a characteristic view showing the relation between the concentration ratio of Sn/Sr of Sn to Sr in a current collector made of a Pb—Sn—Sr alloy foil and a five-hour-rate service capacity;

FIG. 9 shows optical microphotographs of various alloys according to the present invention; and

FIG. 10 shows optical microphotographs of various alloys of comparative examples.

### DETAILED DESCRIPTION OF THE PREFERRED EMBODIMENTS

A lead alloy according to the present invention is basically a Pb—Sn alloy comprising Pb containing 1.3 to 3.0 wt. % Sn. The first alloy includes 0.05 to 0.4 wt. % Sr added in the base alloy to improve corrosion resistance. Sr is added to refine the solidification structure of a cast steel, to raise the recrystallization temperature of the rolled material, to refine recrystallized grains, and to inhibit intergranular corrosion. Added Sr in an amount of less than 0.05 wt. % has an inadequate refining effect for the recrystallized grains, and Sr exceeding 0.4 wt. % has a tendency of increasing an amount of uniform corrosion. Accordingly, the additive amount of Sr is preferably 0.05 to 0.4 wt. %.

The second lead alloy according to the present invention is an alloy comprising a Pb—Sn base alloy comprising Pb containing 1.3 to 3.0 wt. % Sn, 0.05 to 0.4 wt. % Sr, and further 0.05 to 0.20 wt. % one or more elements selected from the group consisting of Ba and Te. Ba and Te are added to improve the hardness of the alloy. An additive amount of less than 0.05 wt. % shows no effect of improving hardness, and an additive amount of more than 0.15 wt. % has a tendency of impairing rollability. Consequently, the additive amount of Ba and Te is preferably 0.05 to 0.20 wt. %. Here, the additive amount of Ba and Te is determined corresponding to the amount of Sr in the specified range.

The third lead alloy according to the present invention is the alloy which comprises a Pb—Sn alloy comprising Pb containing 1.3 to 3.0 wt. % Sn as a base, 0.05 to 0.4 wt. % Sr and further 0.01 to 0.05 wt. % Ca. The element Ca is added to improve the hardness of the alloy. The additive amount of less than 0.01 wt. % shows no effect of improving hardness, and the additive amount of more than 0.05 wt. % lowers a recrystallization temperature to coarsen recrystallized grains, and consequently promotes intergranular corrosion. Accordingly, the additive amount of Ca is preferably 0.01 to 0.05 wt. %. Here, the additive amount of Ca is determined corresponding to the amount of Sr in a specified range.

In an alloy according to the present invention, the concentration ratio Sn/Sr of Sn to Sr is determined in consideration of the concentration of Sn dissolved in an alloy matrix and the amount of Sn and Sr compounds. When the ratio is 7 or lower, the concentration of Sn in the alloy matrix is so low that corrosion resistance decreases, and the amount of the compound is so much that the rollability of the alloy is impaired. In addition, when the ratio is 30 or higher, the amount of the compound having the effect of inhibiting the growth of recrystallized grains and increasing a recrystallization temperature is too little to show the effect of the addition. Accordingly, the ratio is preferably 7 to 30, and further preferably 15 to 25 in terms of cell characteristics.

In addition, a lead alloy according to the present invention is cast, rolled and heat-treated at 160° C. or lower, and then at least one part of the rolled texture acquires a recrystallized structure with an average grain size of 20 μm or smaller, which is suitable for the positive current collector of a lead storage battery. As described above, even when a lead alloy according to the present invention has received a heat load at 160° C. or lower in manufacture and use, at least one part of the rolled texture retains the recrystallized structure with the average grain size of 20 μm or smaller.

In order to remarkably inhibit intergranular corrosion, the average size of recrystallized grains is preferably 20 μm or less. A heat treatment temperature is determined corresponding to the recrystallization temperature of the alloy, but the heat treatment temperature of 160° C. or higher proceeds grain growth into the grains with 20 μm or larger, so that the temperature is preferably 160° C. or lower.

By using a lead alloy according to the present invention, a current-collecting plate for a lead storage battery can be produced. A lead storage battery can be produced by using the current-collecting plate for the lead storage battery with the use of the lead alloy according to the present invention as a component. The lead storage battery is suitable not only for a winding type but also applicable to a multilayered type.

A lead storage battery provided with a current collector, particularly a positive current collector with the use of a lead alloy according to the present invention, can be used as an industrial battery required to have high input characteristics and output characteristics, such as in an electric vehicle, a parallel hybrid electric vehicle, a simple hybrid car, a power storage system, an elevator, an electric power tool, an uninterruptible power supply and a dispersion type power source.

### EXAMPLES

(Experiment)

A rolled sheet having the thickness of 1 mm was prepared by smelting an alloy comprising a Pb—Sn alloy containing Sr, an alloy comprising a Pb—Sn—Sr alloy containing one element selected from the group consisting of Ba and Te, and an alloy comprising a Pb—Sn—Sr alloy containing Ca and cold-rolling them. The rolled sheet was subjected to microstructure observation, micro-Vickers hardness measurement and a corrosion test.

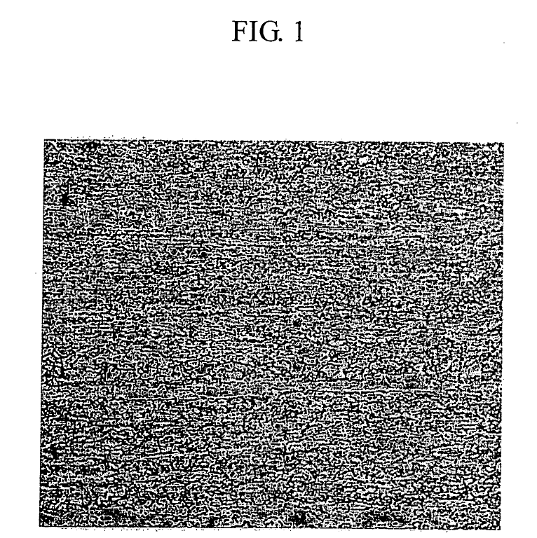

FIG. 1 shows a structure observed with an optical microscope a Pb-2.1 wt. % Sn-0.14 wt. % Sr alloy according to the present invention. The sample was heat-treated at 80° C. for 20 hours. A Pb—Sn alloy of a comparative material was recrystallized in as a rolled state and had a grain size of 50 to 150 μm, whereas the material according to the present invention showed a dense rolled texture on approximately the whole part and had a grain size of 3 μm or smaller even after having been recrystallized. The grain refining effect of Sr was confirmed to appear so long as the additive amount of Sn, Ba, Te or Ca satisfies the claimed ranges according to the present invention.

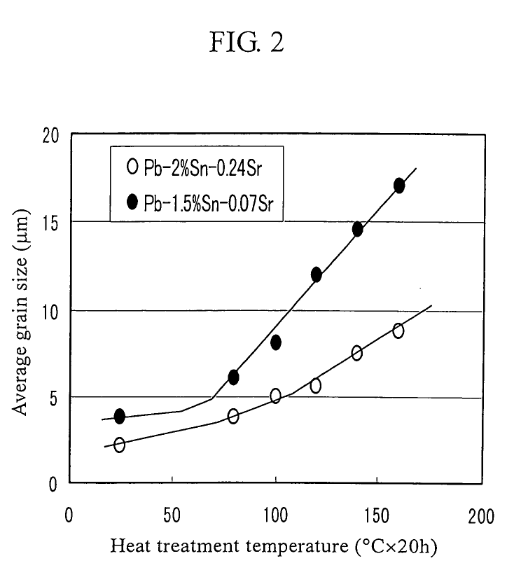

FIG. 2 shows a relation between a heat treatment temperature and a recrystallized grain size. It shows that a Pb-2.0 wt. % Sn-0.24 wt. % Sr alloy and a Pb-1.5 wt. % Sn-0.07 wt. % Sr alloy according to the present invention have recrystallized grain sizes of 20 μm or smaller even after having been heated to 160° C., which are remarkably fine in comparison with the above described Pb—Sn alloy, and that the addition of Sr is effective in increasing a recrystallization temperature.

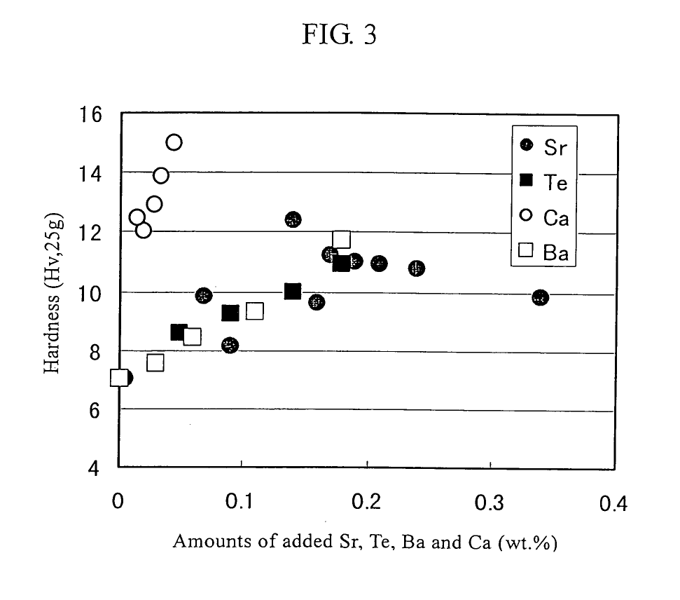

FIG. 3 shows the change of micro-Vickers hardness when Sr, Ba, Te and Ca are respectively separately added to a Pb-2.0 wt. % Sn alloy. Each sample was heat-treated at 80° C. for 20 hours. Any added element has the effect of hardening the Pb—Sn alloy, and particularly Ca had a great effect. In the present invention, the addition of Ba, Te or Ca to the Pb—Sn—Sr alloy was confirmed to enable the alloy to acquire further enhanced hardness, and imparted the alloy such strength as to prevent a current collector from being deformed by the cubical expansion of a corroded layer.

[Corrosion Resistance Evaluation]

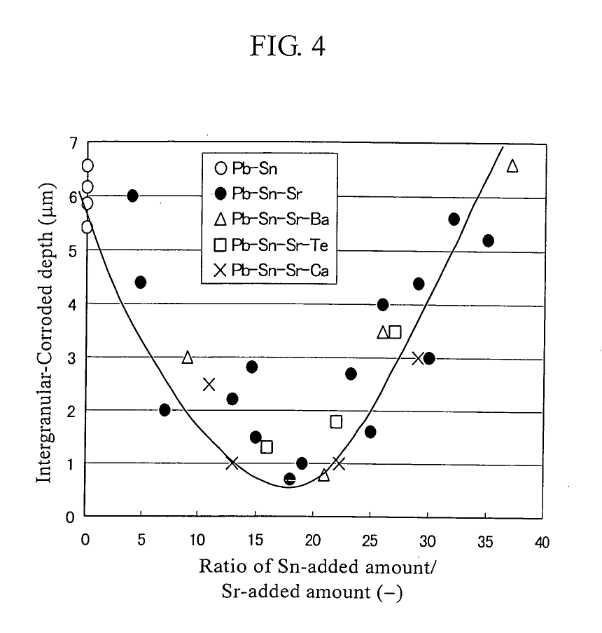

Subsequently, a corrosion test was conducted to evaluate corrosion resistance. The corrosion test was conducted by taking test pieces with the size of 10×50×1 mmt from a rolled material, and continuously applying the current of 10 mA/cm² for 36 hours onto the test pieces in a sulfuric acid electrolytic solution of 30° C. having the specific gravity of 1.280 (20° C.). After the test, a corrosion product formed on the surface of the test piece was removed with a nitric acid solution, and the depth of intergranular corrosion was measured with a laser microscope. FIG. 4 shows the results. It is clear from the figure that the ratio of Sn-added amount/Sr-added amount remarkably affects the intergranular corrosion. This is caused by the refinement of recrystallized grains. It is clear that when the ratio of Sn-added amount/Sr-added amount is 7 to 30, and preferably 15 to 25, the intergranular corrosion was inhibited. It was also confirmed that when the additive amounts of Ba, Te and Ca satisfy the claimed range according to the present invention, the elements did not affect the intergranular corrosion.

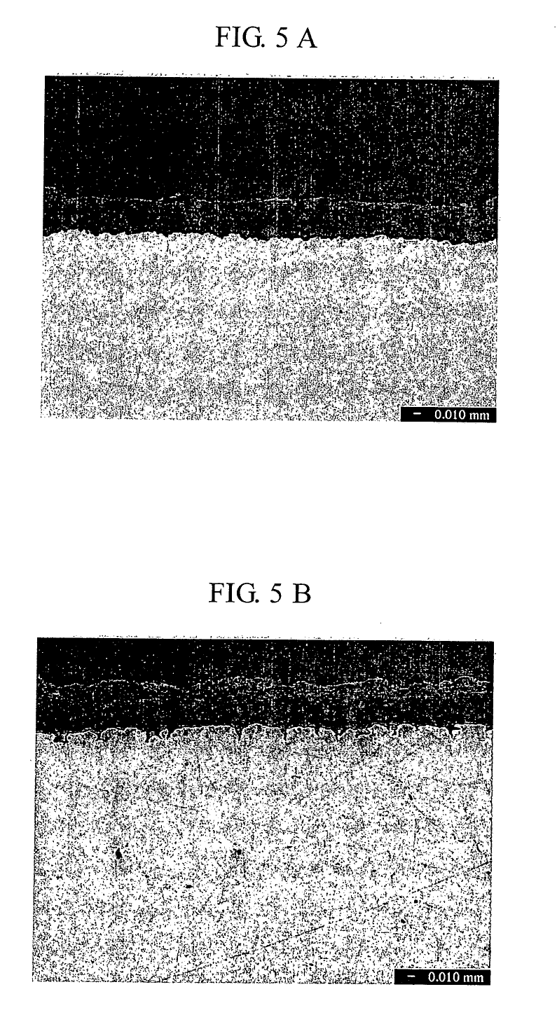

A cycle corrosion test was conducted in order to evaluate corrosion resistance under severer conditions, by repeating the cycle of charging and leaving the test pieces described below for each 6 hours with the current density of 1.25 mA/cm² in a sulfuric acid electrolytic solution of 75° C. having the specific gravity of 1.280 (20° C.), for continuous six weeks. The test pieces with the size of 10×50×1 mmt were taken from the rolled material. After the test, the cross sections of the test pieces including a corroded layer were observed, and the corroded quantity (the total of a uniformly corroded thickness and an intergranular-corroded depth) was determined. FIG. 5A shows an optical microphotograph for the cross section of the corroded layer in a Pb-2.1 wt. % Sn-0.14 wt. % Sr alloy as the representative example of a material according to the present invention. In the photograph, a white part shows an alloy and a gray part above it shows the corroded layer. In addition, FIG. 5B shows the results of a Pb-1.5 wt. % Sn alloy of a conventional material as a comparative sample. In the Pb-1.5 wt. % Sn alloy, intergranular corrosion (a spike-shaped part of a corroded interface in the photograph) clearly occurs, whereas the intergranular corrosion is hardly recognized in a Pb-2.1 wt. % Sn-0.14 wt. % Sr alloy and shows the form of flat uniform corrosion. The thickness of the corroded layer was about 130 μm in a Pb-1.5 wt. %-Sn alloy and was about 185 μm in a Pb-1.1 wt. % Sn-0.08 wt. % Ca alloy, whereas it was about 75 μm in a Pb-2.1 wt. % Sn-0.14 wt. % Sr alloy, which shows superior corrosion resistance.

### EXAMPLES

Referring to specific examples, the present invention will be now described in further detail below, but the present invention is not limited to the examples unless being beyond the purpose of the present invention. In addition, the examples to which the present invention is applied will be described in detail in comparison with a lead storage battery (a comparative example) prepared for confirming the effect of the examples.

At first, a method for preparing a lead storage battery in each example and a comparative example will be described. In examples 2 or higher numbers and comparative examples 1 or higher numbers, the description of the same producing methods as in the example 1 will be omitted, and different methods will be described.

### Example 1

[Preparation of Positive Current Collector]

A Pb—Sn—Sr alloy having a composition according to the present invention was smelted, cold-rolled into a rolled sheet with the thickness of 0.8 mm and was formed into an expanded shape, and the product was used for a positive current collector. The alloy composition of the example 1 is shown in Table 1.

[Preparation of Negative Plate]

A negative plate was prepared by the steps of: at first adding 0.3 wt. % lignin, 0.2 wt. % barium sulfate or strontium sulfate, and 0.1 wt. % carbon powder with respect to lead powder, and kneading them with a kneading machine for about 10 minutes to arrange the mixture; subsequently, adding 12 wt. % water with respect to the lead powder to the lead powder, mixing them, and further adding 13 wt. % dilute sulfinuric acid (with the specific gravity of 1.26 at 20° C.) with respect to the lead powder to prepare the paste of an active material for a negative electrode; and charging 50 g of the paste of the active material for a negative electrode to a current collector made of an expanded lead alloy with the thickness of 0.8 mm, leaving the product in the atmosphere with the humidity of 95% at 50° C. for 18 hours to age it, and then leaving it at 110° C. for two hours to dry it and prepare an unformed negative electrode.

[Preparation of Positive Plate]

A positive plate was prepared by the steps of: at first mixing lead powder with 12 wt. % water with respect to the lead powder and 13 wt. % dilute sulfuric acid (with the specific gravity of 1.26 at 20° C.) with respect to the lead powder, and kneading the mixture to prepare the paste of an active material for a positive electrode; and subsequently charging 60 g of the paste of the active material for a positive electrode to a current collector made of an expanded Pb—Sn—Sr alloy, leaving the product in the atmosphere with the humidity of 95% at 50° C. for 18 hours to age it, and then leaving it at 110° C. for two hours to dry it and prepare an unformed positive plate.

[Preparation and Electrolytic Formation of Multilayered Battery]

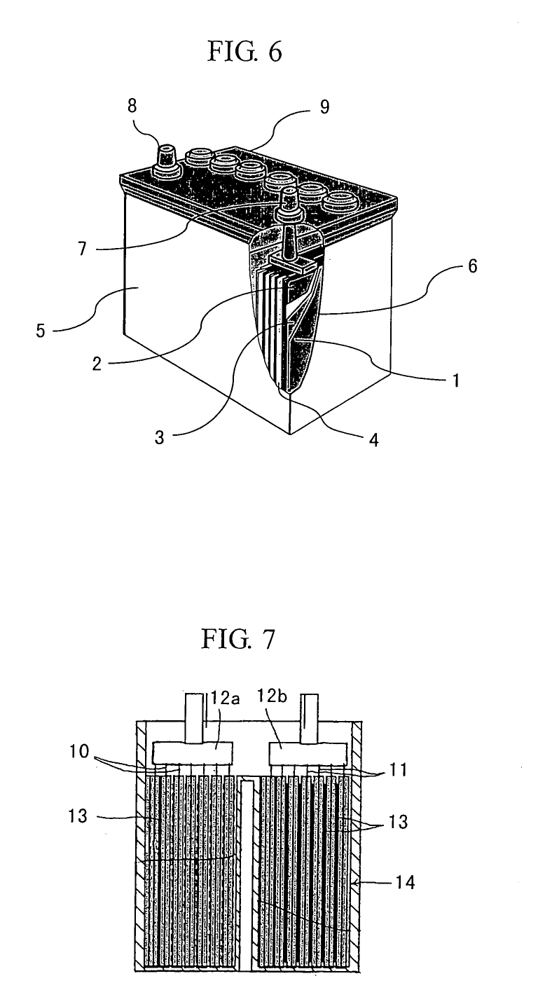

FIG. 6 is a view showing one embodiment according to the present invention. Plate groups 4 were prepared by layering five sheets of unformed negative plates 1 and four sheets of unformed positive plates 2 through a separator 3 made of polypropylene, and connecting plates having the same polarity to each other with a strap. Furthermore, an unformed battery was prepared by connecting the plate groups 4 in six series, arranging them in a battery case 5, and then pouring an electrolytic solution 6 of dilute sulfuric acid with the specific gravity of 1.05 (20° C.). The unformed battery was formed at 9 amperes for 20 hours, the electrolytic solution was drained, and the electrolytic solution of a dilute sulfuric acid having the specific gravity of 1.28 (20° C.) was poured into the battery again. A positive terminal 7 and a negative terminal 8 were welded and the battery case was sealed up with a lid 9 to complete a lead storage battery. The capacity of the obtained battery was 28 Ah, and an average discharge voltage was 12 V.

A lead battery has a configuration of serially connecting several electric cells to acquire a predetermined electric voltage. Here, the prepared battery has the discharge voltage of 12 V and the charging voltage of 14 V, but the battery having the discharge voltage of 36 V and the charging voltage of 42 V can be produced, and the present invention is not limited to the electric voltage range. Accordingly, in the examples according to the present invention, the battery having the discharge voltage of 12 V was prepared, but various characteristics of the present invention do not change depending on the electric voltage range.

[Deep Cycle Test]

As for a deep cycle test, the obtained lead storage battery was subjected to five repetitive discharge and charge cycles of charging the battery at constant current and constant voltage with 5.6 amperes of charging current within a maximum electric voltage of 14.5 V for six hours and discharging it with 5.6 amperes of discharging current till the voltage reaches 10.5 V. The maintenance factor of service capacity in the fifth cycle with respect to the service capacity in the first cycle was determined. The results are shown in Table 1.

TABLE 1

| | | | | | | Capacity maintenance factor |
|---|---|---|---|---|---|---|
| No. | Sn(wt %) | Sr(wt %) | Ba(wt %) | Te(wt %) | Ca(wt %) | (%) in deep cycle test |
| 1 | 1.3 | 0.05 | — | — | — | 45% |
| 2 | 2 | 0.1 | — | — | — | 50% |
| 3 | 2.5 | 0.2 | — | — | — | 55% |
| 4 | 3 | 0.4 | — | — | — | 60% |
| 5 | 1.3 | 0.05 | 0.05 | — | — | 50% |
| 6 | 2 | 0.1 | 0.1 | — | — | 60% |
| 7 | 2.5 | 0.2 | 0.15 | — | — | 65% |
| 8 | 3 | 0.4 | — | 0.15 | — | 20% |
| 9 | 1.3 | 0.05 | — | 0.05 | — | 30% |
| 10 | 1.3 | 0.05 | — | — | 0.02 | 55% |
| 11 | 2 | 0.1 | — | — | 0.04 | 60% |
| 12 | 3 | 0.4 | — | — | 0.05 | 65% |
| 13 | 1.5 | | — | — | — | 10% |

### Example 2

[Preparation of Positive Current Collector]

A Pb—Sn—Sr alloy having a composition according to the present invention was smelted and cold-rolled into a rolled sheet with the thickness of 0.2 mm, which was used for a positive current collector.

[Preparation of Negative Plate]

A negative plate was prepared by the steps of: at first, adding 0.3 wt. % lignin, 0.2 wt. % barium sulfate or strontium sulfate, and 0.1 wt. % carbon powder with respect to lead powder, and kneading them with a kneading machine for about 10 minutes to arrange the mixture; subsequently adding 12 wt. % water with respect to the lead powder to the lead powder, mixing them, and further adding 13 wt. % dilute sulfuric acid (with the specific gravity of 1.26 at 20° C.) with respect to the lead powder to prepare the paste of a negative-electrode active material; and applying the paste of the negative-electrode active material in an amount of 50 g to a current collector consisting of a lead alloy foil with the thickness of 0.2 mm.

[Preparation of Positive Plate]

A positive plate was prepared by the steps of: at first mixing lead powder with 12 wt. % water with respect to the lead powder and 13 wt. % dilute sulfuric acid (with the specific gravity of 1.26 at 20° C.) with respect to the lead powder; kneading the mixture to prepare the paste of an active material for a positive electrode; and subsequently applying 60 g of the paste of the active material for a positive electrode to a current collector with the thickness of 0.2 mm made of a Pb—Sn—Sr alloy foil.

[Preparation and Electrolytic Formation of Winding Battery]

FIG. 7 is a view showing one embodiment according to the present invention. A positive electrode 10 and a negative electrode 11 were wound into a spiral shape through a separator 12 consisting of glass fibers, and the product was left and aged in the atmosphere of 50° C. with the humidity of 95% for 18 hours, and then was left and dried in the atmosphere of 110° C. for two hours. The current-collecting tabs of the positive electrode 10 and the negative electrode 11 were welded to a positive electrode strap 12a and a negative electrode strap 12b by a COS (cast-on-strap) method, and a plate group 13 was obtained. The plate group 13 was inserted into a battery case 14, the top cover was weld, dilute sulfuric acid with the specific gravity of 1.260 was poured into the battery case 14, and the plate group was formed in the battery case to obtain a single cell. The single cells were connected in six series to complete a lead storage battery. The design capacity of the obtained battery was 15 Ah, and an average discharge voltage was 12 V.

[Five-Hour-Rate Capacity Confirmatory Test]

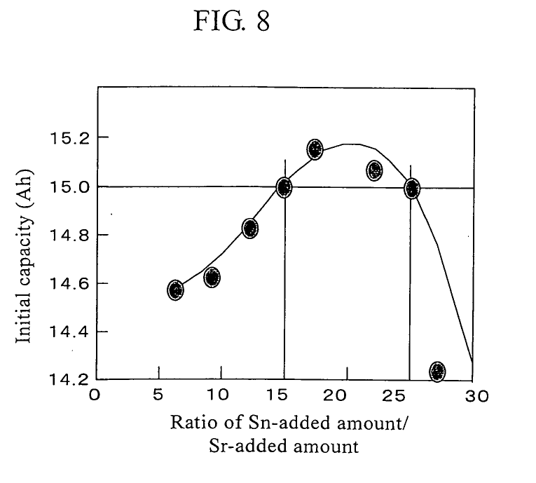

A five-hour-rate capacity was determined by discharging the obtained lead storage battery at 3 amperes of discharging current till the voltage reaches 10.5 V. FIG. 8 shows the relation between the concentration ratio of Sn/Sr of Sn to Sr in a current collector made of a Pb—Sn—Sr alloy foil and the five-hour-rate service capacity. A high service capacity beyond 15 Ah of the design capacity was obtained in the range in which the concentration ratio of Sn/Sr of Sn to Sr is 15 to 25.

### Example 3 and Comparative Example

As in the Example 1, a rolled sheet having the thickness of 1 mm was prepared by smelting an alloy comprising a Pb—Sn alloy containing Sr, an alloy comprising a Pb—Sn—Sr alloy containing one element selected from the group consisting of Ba and Te, and an alloy comprising a Pb—Sn—Sr alloy containing Ca and cold-rolling them. A microstructure was observed with the use of this rolled sheet.

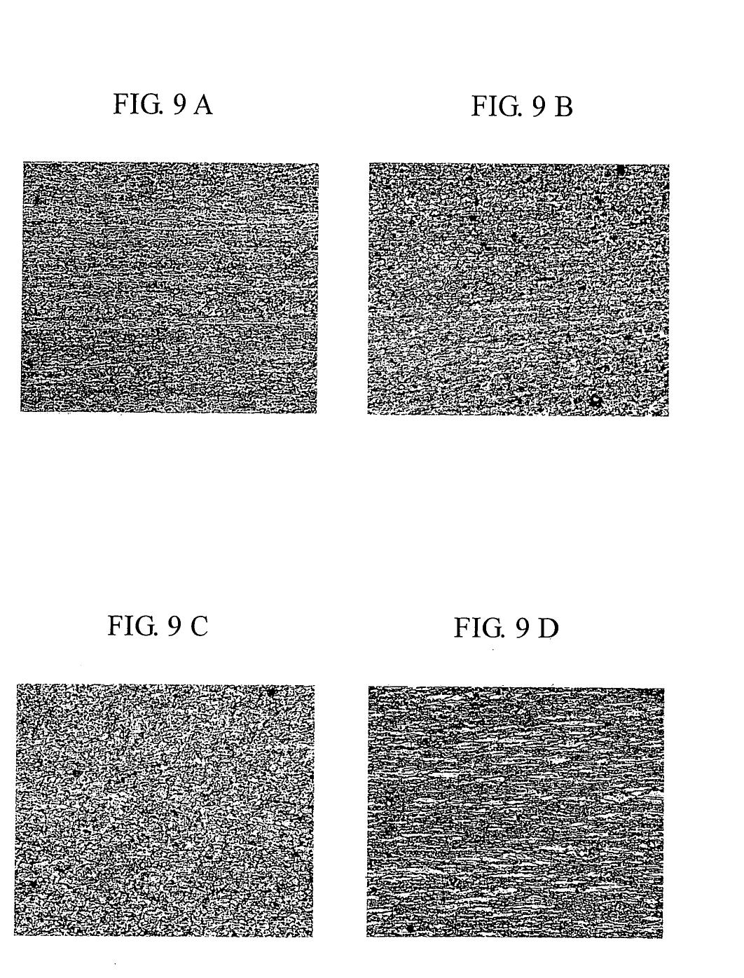

FIG. 9A shows a structure observed with an optical microscope of a Pb-2 wt. % Sn-0.3 wt. % Sr alloy according to the present invention.

FIG. 9B shows a structure observed with an optical microscope of a Pb-2 wt. % Sn-0.3 wt. % Sr-0.2 wt. % Ba alloy according to the present invention.

FIG. 9C shows a structure observed with an optical microscope of a Pb-2 wt. % Sn-0.3 wt. % Sr-0.1 wt. % Te alloy according to the present invention.

FIG. 9D shows a structure observed with an optical microscope of a Pb-2 wt. % Sn-0.2 wt. % Sr-0.08 wt. % Ca alloy according to the present invention.

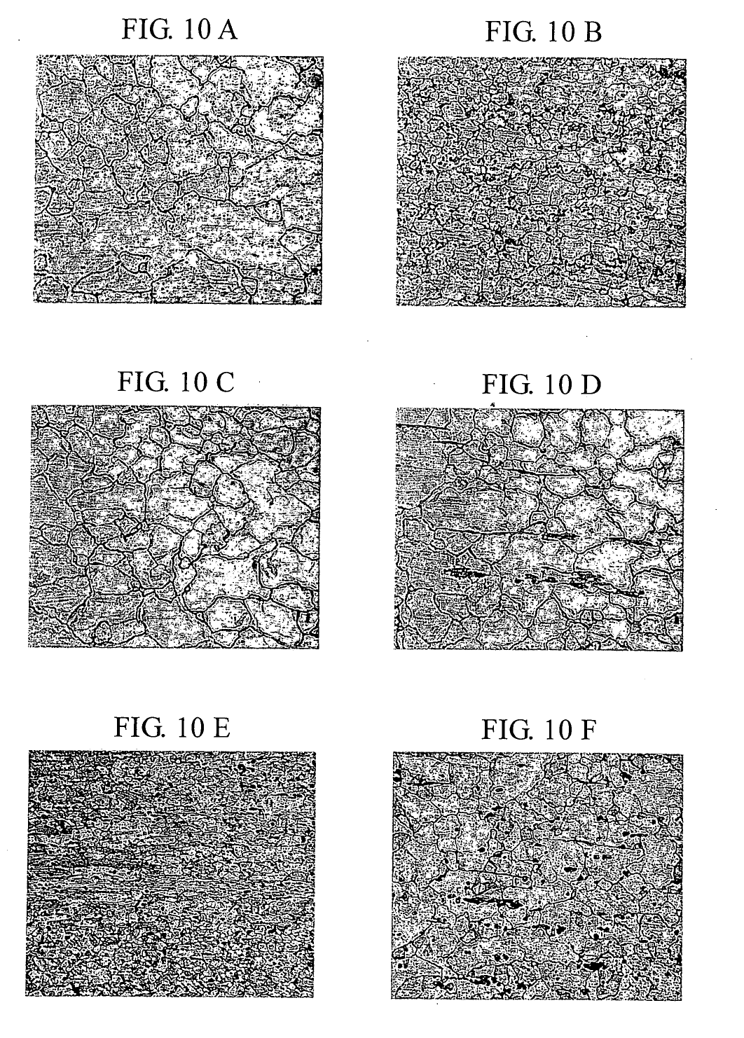

FIG. 10A shows a structure observed with an optical microscope of a Pb-2 wt. % Sn alloy of a comparative material.

FIG. 10B shows a structure observed with an optical microscope of a Pb-2 wt. % Sn-0.3% Te alloy of a comparative material.

FIG. 10C shows a structure observed with an optical microscope of a Pb-2 wt. % Sn-0.3% Ce alloy as a comparative material.

FIG. 10D shows a structure observed with an optical microscope of a Pb-2 wt. % Sn-0.3% In alloy of a comparative material.

FIG. 10E shows a structure observed with an optical microscope of a Pb-2 wt. % Sn-0.3% Ba alloy of a comparative material.

FIG. 10F shows a structure observed with an optical microscope of a Pb-2 wt. % Sn-0.3% misch metal alloy of a comparative material.

Each sample was heat-treated at 80° C. for 20 hours. It is clear that in FIGS. 10A to 10F, each comparative material shows large Pb crystal grains because of containing no Sr, whereas in FIGS. 9A to 9D, each alloy according to the present invention shows extremely small Pb crystal grains because of containing a specified quantity of Sr.

A lead storage battery which uses a lead alloy according to the present invention for a current collector, particularly a positive current collector, can be used as an industrial battery required to have high input characteristics and output characteristics, such as in an electric vehicle, a parallel hybrid electric vehicle, a simple hybrid car, a power storage system, an elevator, an electric power tool, an uninterruptible power supply and a dispersion type power source.

1. A lead alloy comprising 1.3 to 3.0 wt. % Sn, 0.05 to 0.4 wt. % Sr and the balance being Pb with unavoidable impurities.

2. A lead alloy comprising 1.3 to 3.0 wt. % Sn, 0.05 to 0.4 wt. % Sr, further 0.05 to 0.20 wt. % one or more elements selected from the group consisting of Ba and Te, and the balance being Pb with unavoidable impurities.

3. A lead alloy comprising 1.3 to 3.0 wt. %, 0.05 to 0.4 wt. % Sr, further 0.01 to 0.05 wt. % Ca, and the balance being Pb with unavoidable impurities.

4. A lead alloy according to any one of claims 1 to 3, wherein the concentration ratio Sn/Sr of Sn to Sr is 7 to 30.

5. A lead alloy according to any one of claims 1 to 3, wherein at least one part of a rolled texture formed by cold rolling and following heat treatment at 160° C. or lower is a recrystallized structure with an average grain size of 20 μm or smaller.

6. A current collector for a lead storage battery comprising 1.3 to 3.0 wt. % Sn, 0.05 to 0.4 wt. % Sr, and the balance being Pb with unavoidable impurities.

7. A current collector for a lead storage battery comprising 1.3 to 3.0 wt. % Sn, 0.05 to 0.4 wt. % Sr, further 0.05 to 0.20 wt. % one or more elements selected from the group consisting of Ba and Te, and the balance being Pb with unavoidable impurities.

8. A current collector for a lead storage battery comprising 1.3 to 3.0 wt. % Sn, 0.05 to 0.4 wt. % Sr, further 0.01 to 0.05 wt. % Ca, and the balance being Pb with unavoidable impurities.

9. A current collector for a lead storage battery according to any one of claims 6 to 8, wherein the concentration ratio Sn/Sr of Sn to Sr is 7 to 30.

10. A current collector for a lead storage battery comprising a lead alloy of which at least one part of the rolled texture formed by cold rolling and following heat treatment at 160° C. or lower is a recrystallized structure with an average grain size of 20 μm or smaller.

11. A lead storage battery constituted by main components of positive and negative current collectors having an active material on the surface, a separator, an electrolytic solution of a dilute sulfuric acid, a battery case and a lid, wherein the current collectors are formed of a lead alloy comprising 1.3 to 3.0 wt. % Sn, 0.05 to 0.4 wt. % Sr, and the balance being Pb with unavoidable impurities.

12. A lead storage battery constituted by main components of positive and negative current collectors having an active material on the surface, a separator, an electrolytic solution of a dilute sulfuric acid, a battery case and a lid, wherein the current collectors are formed of a lead alloy comprising 1.3 to 3.0 wt. % Sn, 0.05 to 0.4 wt. % Sr, further 0.05 to 0.20 wt. % one or more elements selected from the group consisting of Ba and Te, and the balance being Pb with unavoidable impurities.

13. A lead storage battery constituted by main components of positive and negative current collectors having an active material on the surface, a separator, an electrolytic solution of a dilute sulfuric acid, a battery case and a lid, wherein the current collectors are formed of a lead alloy comprising 1.3 to 3.0 wt. % Sn, 0.05 to 0.4 wt. % Sr, further 0.01 to 0.05 wt. % Ca, and the balance being Pb with unavoidable impurities.

14. A lead storage battery according to any one of claims 11 to 13, wherein the current collector has the concentration ratio Sn/Sr of Sn to Sr of 7 to 30.

15. A lead storage battery according to any one of claims 11 to 13, wherein the current collector has a recrystallized structure with an average grain size of 20 μm or smaller, in at least one part of a rolled texture formed by cold rolling and following heat treatment at 160° C. or lower.

16. A lead storage battery according to any one of claims 11 to 13, wherein the lead storage battery is a winding lead storage battery.

17. A lead storage battery according to claim 14, wherein the lead storage battery is a winding lead storage battery.

18. A lead storage battery according to claim 15, wherein the lead storage battery is a winding lead storage battery.
